(19) United States
(12) Patent Application Publication
(10) Pub. No.: US 2016/0182257 A1
(43) Pub. Date: Jun. 23, 2016

(54) DATA RATE DETECTION TO SIMPLIFY RETIMER LOGIC

(71) Applicant: Intel Corporation, Santa Clara, CA (US)

(72) Inventors: Daniel Froelich, Portland, OR (US); Zuoguo Wu, San Jose, CA (US); Anupriya Sriramulu, Santa Clara, CA (US)

(73) Assignee: Intel Corporation, Santa Clara, CA (US)

(21) Appl. No.: 14/582,105

(22) Filed: Dec. 23, 2014

(51) Int. Cl. H04L 25/02; H04L 25/03

(52) U.S. Cl. CPC H04L 25/0262; H04L 25/03885

(57) ABSTRACT

An apparatus is described herein. The apparatus comprises a physical layer (PHY), wherein analog circuitry of the physical layer is to determine a data rate. The apparatus also comprises a media access layer (MAC), wherein the media access layer is to receive the data rate from the physical layer.

### FIELD

The present techniques generally relate to retimers that support multiple data rates. More specifically, the present techniques relate to data rate detection in the physical layer (PHY) of the retimer.

### BACKGROUND

Retimers are used as a method for extending the physical length of an interconnect. When the retimer is to support multiple data rates, data rate detection occurs at the retimer to properly retime the signal. Data rate detection typically programming a predetermined data rate at the PHY, and then assessing data transmitted by the PHY in order to determine if the data speed is correct. Digital logic to the PHY is used to determine if the data speed is correct. If the predetermined data rate is incorrect, the data rate at the PHY is reset. Once the correct data rate is determined, the retimer can then transmit data.

### BRIEF DESCRIPTION OF THE DRAWINGS

FIG. 1 is an illustration of layers of an interconnect model;

FIG. 2 is a diagram of layers of a retimer;

FIG. 3 is block diagram of a circuit to perform speed detection in the PHY;

FIG. 4 is a process flow diagram of a method for detecting data rates in a PHY;

FIG. 5 is a block diagram showing tangible, non-transitory computer-readable media that stores code for data rate detection; and

FIG. 6 is a block diagram of an exemplary computer system.

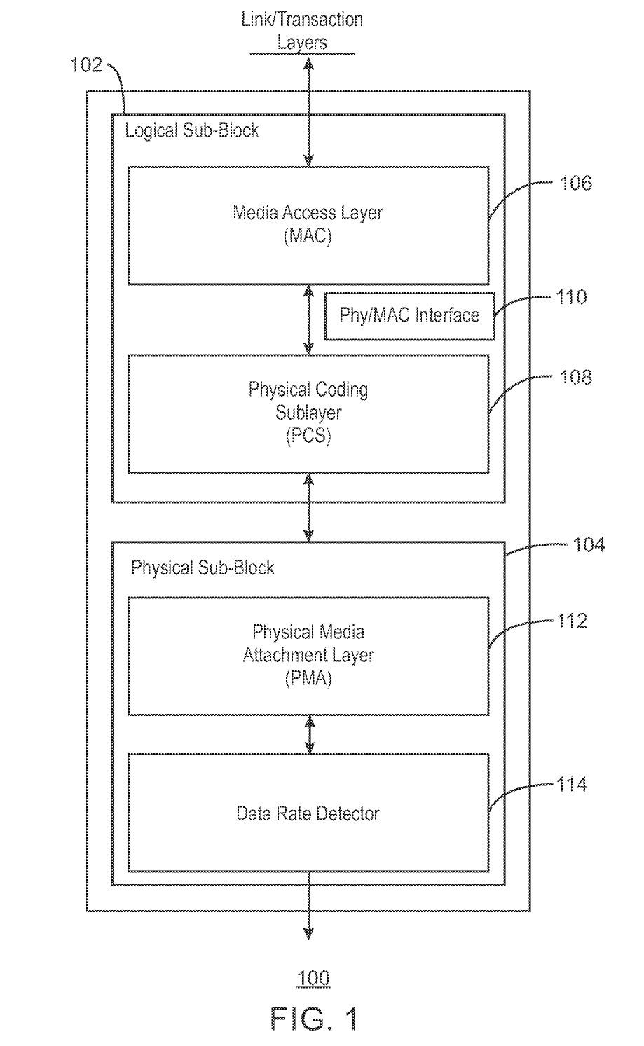

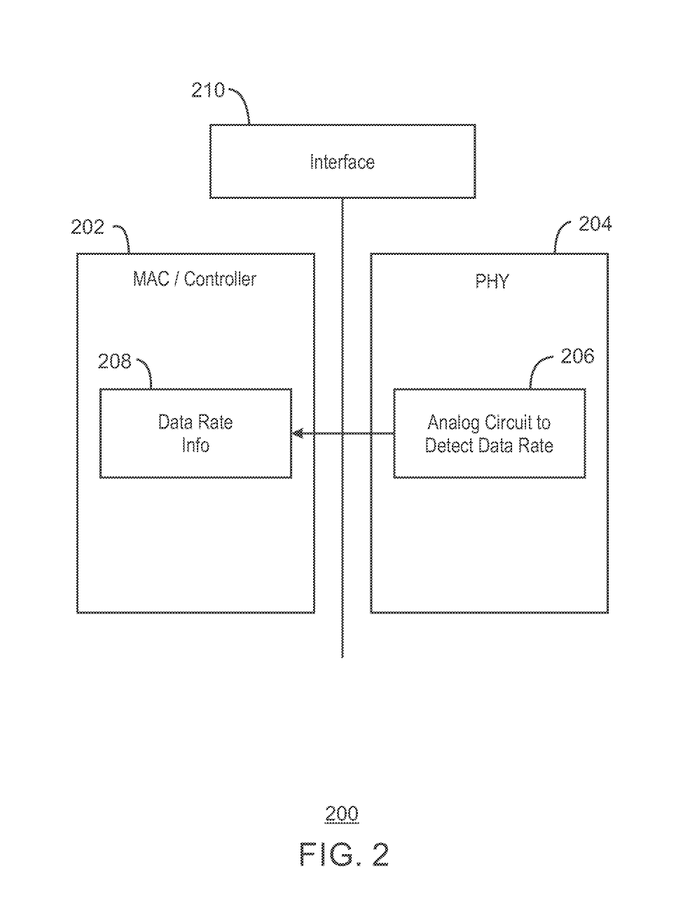

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Retimers may be protocol aware, such that retimers can retime data according to multiple protocols. Such protocols may include: a Peripheral Component Interconnect (PCI) Express (PCIe) Specification, such as the PCIe 3.0 released on Nov. 10, 2010; a Universal Serial Bus (USB) Specification, such as the USB 3.1 Specification released on Jul. 26, 2013, or a Serial ATA (SATA) Specification, such as the SATA 3.2 Specification released in August 2013. Various generations of each protocol can support a different data rate. For example, the PCI architecture can operate at data rates of 2.5, 5, 8, and 16 giga-transfers per second (GT/s). A multiple data rate retimer can support all data rates of a protocol. To support multiple data rates, the retimer performs data rate detection to properly retime the data. Traditionally, the data rate detection is performed with a purely digital approach. A purely digital approach may result in errors in the retimed signal.

Embodiments described herein determine the data rate in the PHY of the retimer. This eliminates the need to program a particular data rate in the PHY, and then any subsequent assessment on if the data rate is correct. In this manner, latency is reduced when the multiple data rate retimer is to begin to transmit data again.

In the following description, numerous specific details are set forth, such as examples of specific types of processors and system configurations, specific hardware structures, specific architectural and micro architectural details, specific register configurations, specific instruction types, specific system components, specific measurements/heights, specific processor pipeline stages and operation etc. in order to provide a thorough understanding of the present invention. It will be apparent, however, to one skilled in the art that these specific details need not be employed to practice the present invention. In other instances, well known components or methods, such as specific and alternative processor architectures, specific logic circuits/code for described algorithms, specific firmware code, specific interconnect operation, specific logic configurations, specific manufacturing techniques and materials, specific compiler implementations, specific expression of algorithms in code, specific power down and gating techniques/logic and other specific operational details of computer system haven't been described in detail in order to avoid unnecessarily obscuring the present invention.

Although the following embodiments may be described with reference to energy conservation and energy efficiency in specific integrated circuits, such as in computing platforms or microprocessors, other embodiments are applicable to other types of integrated circuits and logic devices. Similar techniques and teachings of embodiments described herein may be applied to other types of circuits or semiconductor devices that may also benefit from better energy efficiency and energy conservation. For example, the disclosed embodiments are not limited to desktop computer systems or Ultrabooks™. And may be also used in other devices, such as handheld devices, tablets, other thin notebooks, systems on a chip (SOC) devices, and embedded applications. Some examples of handheld devices include cellular phones, Internet protocol devices, digital cameras, personal digital assistants (PDAs), and handheld PCs. Embedded applications typically include a microcontroller, a digital signal processor (DSP), a system on a chip, network computers (NetPC), set-top boxes, network hubs, wide area network (WAN) switches, or any other system that can perform the functions and operations taught below. Moreover, the apparatus', methods, and systems described herein are not limited to physical computing devices, but may also relate to software optimizations for energy conservation and efficiency. As will become readily apparent in the description below, the embodiments of methods, apparatus', and systems described herein (whether in reference to hardware, firmware, software, or a combination thereof) are vital to a ‘green technology’ future balanced with performance considerations.

As computing systems are advancing, the components therein are becoming more complex. As a result, the interconnect architecture to couple and communicate between the components is also increasing in complexity to ensure bandwidth requirements are met for optimal component operation. Furthermore, different market segments demand different aspects of interconnect architectures to suit the market's needs. For example, servers require higher performance, while the mobile ecosystem is sometimes able to sacrifice overall performance for power savings. Yet, it is a singular purpose of most fabrics to provide highest possible performance with maximum power saving. Below, a number of interconnects are discussed, which would potentially benefit from aspects of the invention described herein.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is an illustration of layers of an interconnect model 100. The interconnect model 100 may illustrate layers of a multiple data rate retimer. In examples the interconnect model 100 includes a physical layer (PHY). The PHY may include hardware transmission technologies components of an interconnect. In some cases, the PHY may define the transmission of raw bits or data packets of the interconnect. The physical layer may provide the electrical, mechanical, and procedural interface to the transmission medium. Further, the characteristics of the electrical connectors, the frequencies used by the particular physical layer, the modulation scheme to use and similar low-level parameters, are specified by the PHY. Parameters may differ according to the particular protocol supported by the PHY. Although particular specifications are listed, the present techniques can be used with any input/output protocol.

The interconnect model 100 includes a logical sub-block 102 and a physical sub-block 104. In the present scenario, the logical sub-block 102 is responsible for the “digital” functionality of the interconnect model 100. In this regard, the logical sub-block 104 includes a media access layer (MAC) 106 and a physical coding sub layer (PCS) 108. In embodiments, the MAC 106 enables addressing and channel access control mechanisms for the retimer. In embodiments, the MAC 106 is an interface between a logical link control (LLC) sub layer and the physical layer (PHY). The PCS 108 performs data encoding/decoding, scrambling/descrambling, alignment marker insertion/removal, block and symbol redistribution, and lane block synchronization and deskew, among others.

A PHY/MAC interface 110 is disposed between the MAC layer 106 and the PCS 108. The PHY/MAC interface 110 is an interface between a PHY and MAC that includes particular functionality that is incorporated into the PHY. In embodiments, the PHY/MAC interface is a PHY Interface for the PCI Express (PIPE) interface. In embodiments, the interface may also be a PHY interface for a SATA and USB SuperSpeed Architectures.

The physical sub-block 104 includes a physical media attachment (PMA) layer 112 and a data rate detector 114. In the present scenario, the physical sub-block is responsible for the “analog” functionality of the interconnect model 100. The PMA layer 112 may encode data to the PCS 108. In embodiments, the PCS 108 may be configured to perform coding and decoding of data transmitted between PMA layer 112 and the MAC 106. The data rate detector 114 includes bus speed detection. In embodiments, the data rate detector is stand alone analog circuitry that detects the data rate of data being transmitted by an interconnect that includes the retimer.

In this manner, bus speed detection is moved into a circuit in the retimer analog circuitry, greatly simplifying the retimer digital logic implementation. In embodiments, the bus speed detection is performed by an analog circuit of the PHY layer. Additionally, in embodiments PCS 108, PMA layer 112, and data rate detector are components of the PHY layer of the interconnect model 100, while the MAC 106 is a component of a data link layer.

The diagram of FIG. 1 is not intended to indicate that the interconnect 100 is to include all of the components shown in FIG. 1. Any number of additional components may be included within the interconnect 100, depending on the details of the devices and specific implementation of the retimer described herein. For example, the items discussed are not limited to the functionalities mentioned, but the functions could be done in different places, or by different components.

FIG. 2 is a diagram of layers 200 of a retimer. The layers 200 include MAC/Controller 202 and a PHY layer 204. The PHY 204 includes an analog circuit 206, where the analog circuit 206 is to detect a data rate of the interconnect. Once this data rate is detected, it is sent to the MAC/Controller 202 as data rate information 208. The data rate is sent across an interface 210. In embodiments, the interface 210 is a PIPE interface. The PIPE interface is an example of an interface that could be used between the PHY and MAC/controller one implementation. However, the general partitioning illustrated can be used with several interfaces, regardless of the specific internal interface used.

Traditionally, the MAC/Controller 202 would program the data rate in the PHY layer to an expected the data rate to be something when the link begins transmitting data, or exits an idle state. In electrical idle state, the positive and negative signals are not being driven. When transfer is restarted from the electric idle, the sender must implement a training session in order to rebuild links with the receiver. In some cases, the data rate changes after an electrical idle state, and the retimer is to determine the new data rate. After the rate is programmed, the MAC/Controller 202 would check the incoming data in the PHY by assessing the data/error information and then deciding if the speed is correct.

Determining the new data rate through a purely digital scheme is error prone, as endpoints coupled with the retimer may change data rates due to internal error without sending a notification on the link of the new data rate. The present techniques determine the data speed in the PHY. This eliminates the need to program a particular data rate in the PHY, and then any subsequent assessment on if the data rate is correct. In this manner, and latency is reduced when the multiple data rate retimer is to begin to transmit data again.

In the case of a PCIe protocol, a link exit may be known as a transition to an electric idle as described by the PCIe specification. In embodiments, the MAC/Controller is to program the new data rate in advance. However, programming the new data rate using the MAC/controller may be inherently error prone, as devices may unexpectedly transition data rates due to internal errors. This is especially true when the data rate is programmed back to a lower data rate. For example, in a PCIe scenario, when the data rate is back to the starting 2.5 GT/s rate without changing a data rate of the retimer, errors may be introduced into the data transmission. This results in the data rate programming being incorrect at times. Traditionally, additional digital logic is placed in the MAC/Controller to detect these error prone cases and reprogram the speed correctly. However, this logic is error prone and difficult to debug. In embodiments, the present techniques present a model where a PHY contains analog circuitry to perform fast speed detection every time the link changes data rate. In the case of a PCIe protocol, the analog circuitry is to perform fast speed detection every time the link exits an Electrical Idle state according to the PCI-E Specification. The detected speed is then relayed to the MAC/Controller. This architecture eliminates the need for all digital logic in the MAC/Controller of the retimer involved in monitoring traffic to predict rate changes and error logic to detect when the predicted/programmed rate is incorrect. In this manner, the digital logic of the retimer can be greatly simplified.

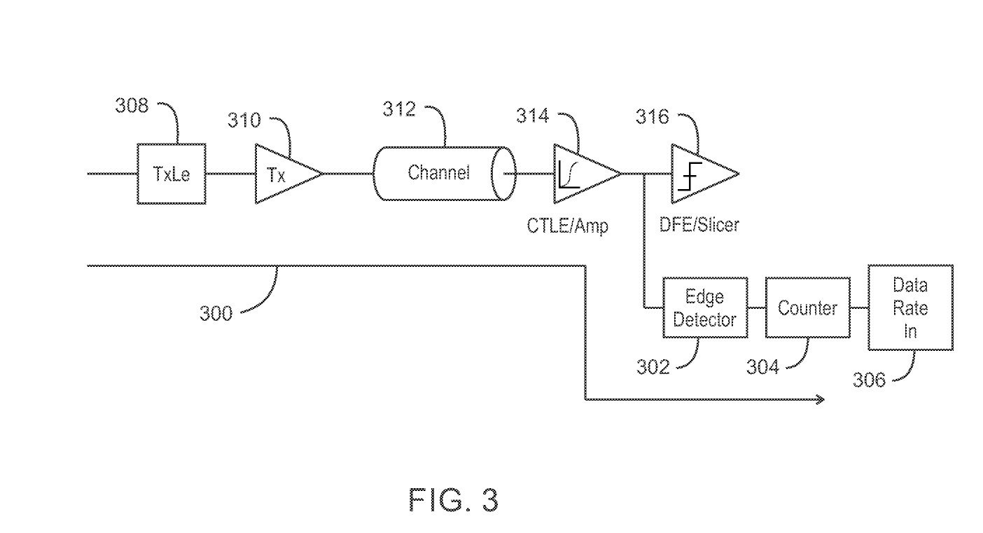

FIG. 3 is block diagram of a circuit to perform speed detection in the PHY. The path 300 illustrates a signal path for the data rate detection. In embodiments, an edge detector 302 and the counter 304 form the analog circuitry in the PHY that is to enable speed detection in the PHY. Equalization may be performed on the data in order to ensure operation of the edge detector.

The data path 300 may travel along various components that can incur Inter-Symbol Interference. Inter-Symbol Interference (ISI) generally refers to a form of signal distortion where one symbol interferes with subsequent symbols in a data stream. Distortion due to ISI is typically found in high speed I/O communications. To minimize ISI, high speed links perform various equalization steps. In particular, equalization may be performed at a transmitter in order to minimize distortion of a high speed signal transmitted along a high speed interconnect.

For example, a transmission linear equalization (TxLE) 308 typically includes adaptively filtering the signal at the transmitter using coefficients that are determined at runtime and dependent upon the physical channel. A transmission driver 310 transmits data from the TxLE 308 to a channel 312. The transmission driver 310 may also emphasize a high frequency content of the transmitted signal over the lower frequency content in order to counteract channel-induced distortion at high frequencies. The channel 312 may transmit the data according to a particular protocol. For example, the circuit 300 may transmit data according to a PCI protocol. A continuous time linear equalization (CTLE) and amplifier (Amp) 314 may be applied to the data signal to compensate ISI and also amplify the data signal. A decision feedback equalizer (DFE) 316 can be used to further mitigate ISI during signal processing. In embodiments, a slicer 316 can be sufficient to further mitigate ISI during signal processing.

In order to determine the data rate using an analog circuit in the PHY, a combination of transmitter equalization and receiver continuous time linear equalization is performed to recover data transition edges. Without equalization, some data transition edges may be missing. Accordingly, with strategically selected transmitter equalization and receiver continuous time linear equalization, the edge detector 302 followed by the counter will output a number of edges for a given measurement period. With the number of edges, the data rate can be determined, as indicated at the data rate in 306.

In some cases, the TxLE and CTLE can be used to over-equalize the signal such that a number of data transition edges can be detected. Over equalization means that TxLE and CTLE have a higher frequency gain when compared to the loss incurred by the channel. As such, combined TxLE, CTLE, and channel has more gain at high frequency than low frequency. As used herein, over equalization can still provide proper equalization for detecting the edge transitions. Accordingly, TX equalization and RX CTLE settings can be optimized to enable data rate detection in the PHY. In embodiments, simulation can be used to determine the proper TX equalization and RX CTLE setting. In the example of a PCIe protocol, for a target channel with insertion loss of 25 dB, using TX equalization preset #7 as defined by PCI Express Specification and CTLE peaking, DC-to-AC gain, ranging from 6 dB to 16 dB results in an edge number accuracy within one percent of the theoretical number. By comparison, if no equalization is used, more than 50% of the edges will be lost. Since the range of workable CTLE peaking is quite wide, most of the PCI Express RX design will likely to have some of the CTLE settings within the range. This means the existing RX CTLE and TX equalization circuit according to PCI can be reused for this purpose. Often times setting the existing RX CTLE to max peaking and TX equalization to preset #7 will be sufficient. The only additional circuits are edge detector and counter.

In embodiments, the counter 304 is implemented digitally. Since the output of RX CTLE amplifier are often low swing current mode logic (CML), a CML edge detector may be used. The CML edge detector has higher power than a digital edge detector. In such a scenario, the edge detector and counter is turned off once the data rate detection operation is completed. In embodiments, the edge detection circuit may have a bit of error. For example, since a line data rate difference between PCIe generations is approximately 1.6-2×, a few percentage error in edge detection will not cause an incorrect classification.

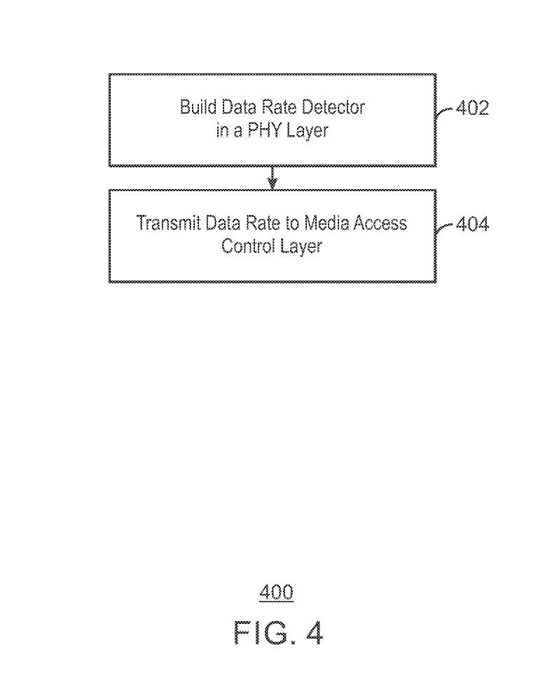

FIG. 4 is a process flow diagram of a method 400 for detecting data rates in a PHY. At block 402, a data rate detector is built in a PHY layer. In embodiments, the data rate detector includes an edge detector and a counter. The counter may be implemented digitally within the PHY.

At block 404, the data rate detected by the data rate detector is transmitted to the media access control layer. In some embodiments, a PIPE interface is between the PHY layer and the media access control layer. Accordingly, in some embodiments, the data rate information is transmitted to the media access control layer using the PIPE interface.

The method 400 of FIG. 4 is not intended to indicate that method 400 is to include all of the steps shown in FIG. 4. Further, any number of additional steps may be included within the method 400, depending on the details and specific implementation of the analog circuitry as described herein.

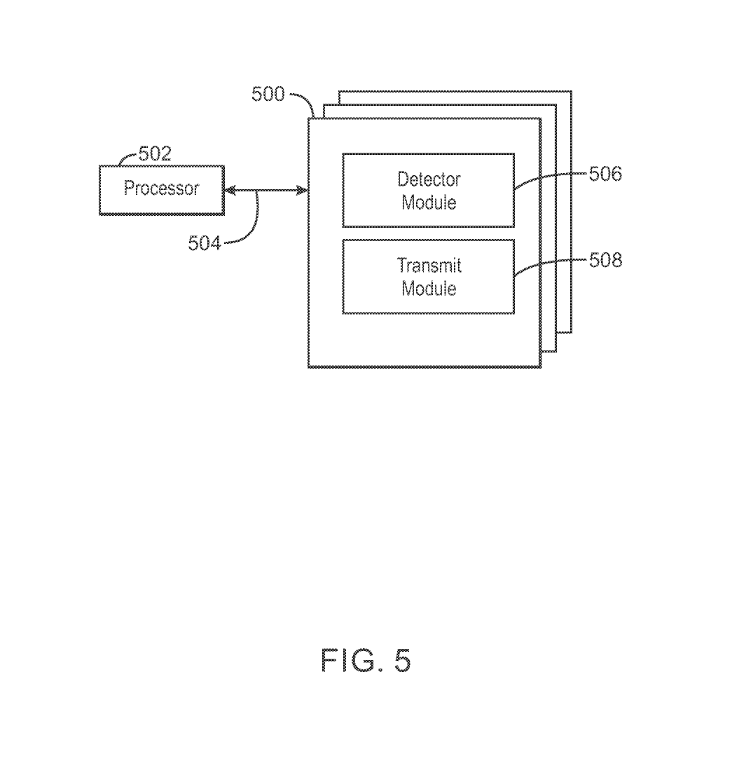

FIG. 5 is a block diagram showing tangible, non-transitory computer-readable media 500 that stores code for data rate detection. The tangible, non-transitory computer-readable media 500 may be accessed by a processor 502 over a computer bus 504. Furthermore, the tangible, non-transitory computer-readable medium 500 may include code configured to direct the processor 502 to perform the methods described herein.

The various software components discussed herein may be stored on one or more tangible, non-transitory computer-readable media 500, as indicated in FIG. 5. For example, a detector module 506 may be configured to detect a data rate at a PHY level of the retimer. A transmit module 508 may be configured to transmit the detected data rate. The data rate may be sent to a MAC layer using a PIPE interface.

The block diagram of FIG. 5 is not intended to indicate that the tangible, non-transitory computer-readable media 500 is to include all of the components shown in FIG. 5. Further, the tangible, non-transitory computer-readable media 500 may include any number of additional components not shown in FIG. 5, depending on the details of the specific implementation.

In embodiments, the present techniques renders the digital logic necessary to implement a PCI Express 3.0/4.0 Retimer simpler when compared to the logic necessary if speed detection and incorrect speed programming logic is handled in the digital logic of the retimer. Moreover, the present techniques makes a retimer implementation much easier to test and debug when compared to the digital logic. Furthermore, the present techniques greatly reduce the amount of time it takes the retimer to correctly determine or confirm the data rate once the link exits electrical IDLE according to the PCI Specification, and thus the time it takes for the Retimer to start forwarding data. Minimizing this time makes the retimer less likely to create interoperability issues when used in links with existing devices.

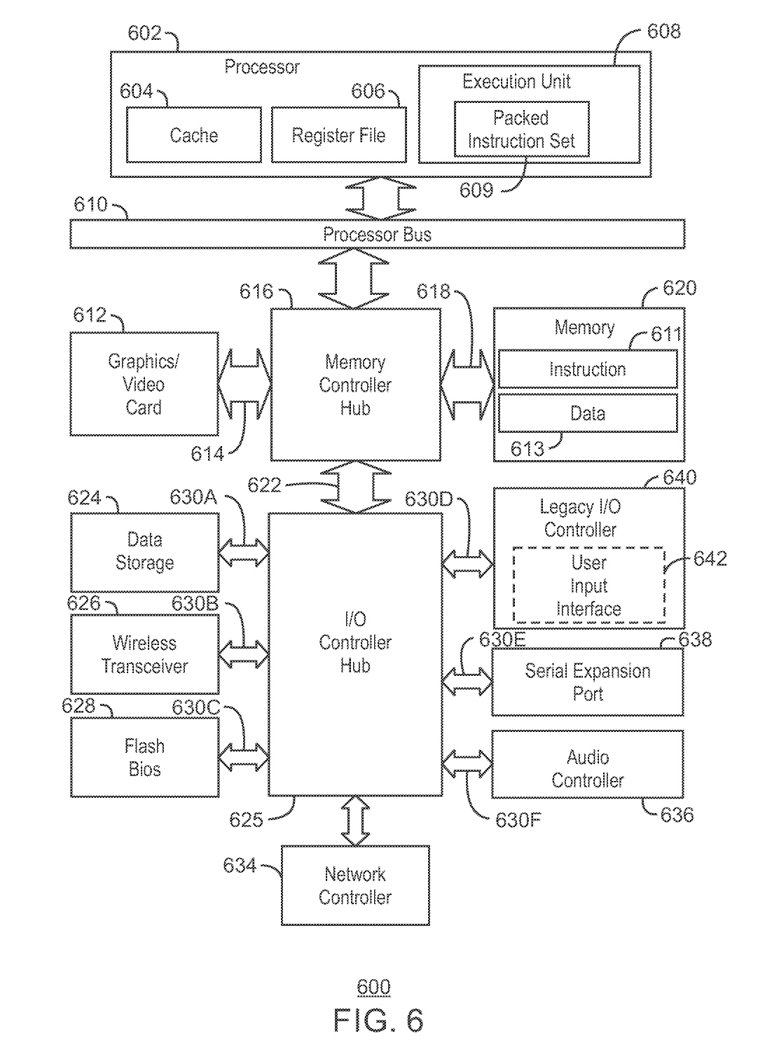

FIG. 6 is a block diagram of an exemplary computer system 600. The system 600 includes a processor with execution units to execute an instruction, where one or more of the interconnects implement one or more features in accordance with one embodiment of the present invention is illustrated. The system 600 includes a component, such as a processor 602 to employ execution units 608 including logic to perform algorithms for process data, in accordance with the present invention, such as in the embodiment described herein. In some cases, system 600 is representative of processing systems based on the PENTIUM III™, PENTIUM 4™, Xeon™, Itanium, XScale™and/or StrongARM™ microprocessors available from Intel Corporation of Santa Clara, Calif., although other systems (including PCs having other microprocessors, engineering workstations, set-top boxes and the like) may also be used. In embodiments, system 600 executes a version of the WINDOWS™ operating system available from Microsoft Corporation of Redmond, Wash., although other operating systems (UNIX and Linux for example), embedded software, and/or graphical user interfaces, may also be used. Thus, embodiments of the present invention are not limited to any specific combination of hardware circuitry and software.

The embodiments described herein are not limited to computer systems. Alternative embodiments of the present techniques can be used in other devices, such as handheld devices and embedded applications. Some examples of handheld devices include cellular phones, Internet Protocol devices, digital cameras, personal digital assistants (PDAs), and handheld PCs. Embedded applications can include a micro controller, a digital signal processor (DSP), system on a chip, network computers (NetPC), set-top boxes, network hubs, wide area network (WAN) switches, or any other system that can perform one or more instructions in accordance with at least one embodiment.

In this illustrated embodiment, processor 602 includes one or more execution units 608 to implement an algorithm that is to perform at least one instruction 611. One embodiment may be described in the context of a single processor desktop or server system, but alternative embodiments may be included in a multiprocessor system. System 600 is an example of a ‘hub’ system architecture. The computer system 600 includes a processor 602 to process data signals. The processor 602, as one illustrative example, includes a complex instruction set computer (CISC) microprocessor, a reduced instruction set computing (RISC) microprocessor, a very long instruction word (VLIW) microprocessor, a processor implementing a combination of instruction sets, or any other processor device, such as a digital signal processor, for example. The processor 602 is coupled to a processor bus 610 that transmits data signals between the processor 602 and other components in the system 600. The elements of system 600 (e.g. graphics accelerator 612, memory controller hub 616, memory 620, I/O controller hub 625, wireless transceiver 626, Flash BIOS 628, Network controller 609, Audio controller 636, Serial expansion port 638, I/O controller 640, etc.) perform their conventional functions that are well known to those familiar with the art.

In one embodiment, the processor 602 includes a Level 7 (L1) internal cache memory 604. Depending on the architecture, the processor 602 may have a single internal cache or multiple levels of internal caches. Other embodiments include a combination of both internal and external caches depending on the particular implementation and needs. Register file 606 is to store different types of data in various registers including integer registers, floating point registers, vector registers, banked registers, shadow registers, checkpoint registers, status registers, and instruction pointer register.

Execution unit 608, including logic to perform integer and floating point operations, also resides in the processor 602. The processor 602, in one embodiment, includes a microcode (ucode) ROM to store microcode, which when executed, is to perform algorithms for certain macroinstructions or handle complex scenarios. Here, microcode is potentially updateable to handle logic bugs/fixes for processor 602. For one embodiment, execution unit 608 includes logic to handle a packed instruction set 609. By including the packed instruction set 609 in the instruction set of a general-purpose processor 602, along with associated circuitry to execute the instructions, the operations used by many multimedia applications may be performed using packed data in a general-purpose processor 602. Thus, many multimedia applications are accelerated and executed more efficiently by using the full width of a processor's data bus for performing operations on packed data. This potentially eliminates the need to transfer smaller units of data across the processor's data bus to perform one or more operations, one data element at a time.

Alternate embodiments of an execution unit 608 may also be used in micro controllers, embedded processors, graphics devices, DSPs, and other types of logic circuits. System 600 includes a memory 620. Memory 620 includes a dynamic random access memory (DRAM) device, a static random access memory (SRAM) device, flash memory device, or other memory device. Memory 620 stores instructions 611 and/or data 613 represented by data signals that are to be executed by the processor 602.

Note that any of the aforementioned features or aspects of the present techniques may be utilized on one or more interconnects illustrated in FIG. 6. For example, an on-die interconnect (ODI), which is not shown, for coupling internal units of processor 602 implements one or more aspects of the invention described above. The invention is associated with a processor bus 610 (e.g. Intel Quick Path Interconnect (QPI) or other known high performance computing interconnect), a high bandwidth memory path 618 to memory 620, a point-to-point link to graphics accelerator 614 (e.g. a Peripheral Component Interconnect express (PCIe) compliant fabric), a controller hub interconnect 622, and an I/O or other interconnect (e.g. USB, PCI, PCIe) 630A, 630B, 630C, 630D, 630E, and 630F for coupling the other illustrated components. Some examples of such components include the audio controller 636, firmware hub (flash BIOS) 628, wireless transceiver 626, data storage 624, legacy I/O controller 610 containing user input and keyboard interfaces 642, a serial expansion port 638 such as Universal Serial Bus (USB), and a network controller 609. The data storage device 624 can comprise a hard disk drive, a floppy disk drive, a CD-ROM device, a flash memory device, or other mass storage device.

The block diagram of FIG. 6 is not intended to indicate that the computing device 600 is to include all of the components shown in FIG. 6. Further, the computing device 600 may include any number of additional components not shown in FIG. 6, depending on the details of the specific implementation.

### EXAMPLE 1

An apparatus is described herein. The apparatus comprises a physical layer (PHY) and a media access layer. Analog circuitry of the physical layer is to determine a data rate, and the media access layer is to receive the data rate from the physical layer.

The analog circuitry may comprise an edge detector and a counter. The edge detector may be a current mode logic (CML) edge detector. An equalization value of a signal may be increased to determine the data rate. An equalization value may be a maximum value. The apparatus may include interface between the physical layer and the media access layer, and wherein the data rate may be sent from the physical layer to the media access layer using the interface. The interface may be a PHY Interface for the PCI Express, SATA, and USB SuperSpeed Architectures (PIPE) interface. The apparatus may support a Peripheral Component Interconnect (PCI) Express (PCIe) Specification, a Universal Serial Bus (USB) Specification, a Serial ATA (SATA) Specification, or any combination thereof. The data rate may be determined in response to a link exiting an electric idle state. The analog circuitry may be powered off in response to determining the data rate.

### EXAMPLE 2

A system is described herein. The system comprises a transmission equalization (TxLe) component and a continuous time linear equalization (CTLE) component. The system also comprises a physical layer (PHY) and a media access layer (MAC). Analog circuitry of the physical layer is to determine a data rate, the analog circuitry comprising an edge detector and a counter, and wherein the TxLE and the CTLE are to enable an equalization condition where the edge detector and counter are to determine the data rate. The media access layer is to receive the data rate from the physical layer.

The edge detector may be a current mode logic (CML) edge detector. Data may be transferred according to a PCI protocol, and wherein the equalization condition comprises a TX equalization preset #7. The equalization condition may be equalization of a signal such that a substantial number of edges are to be detected. The counter may be implemented digitally. The edge detector may be a CML detector. A number of edges detected by the edge detector in a predetermined time period may determine the data rate of the a link. A time to forward data after the link exists electric IDLE may be decreased. The system may comprise an interface between the physical layer and the media access layer, and wherein the data rate may be sent from the physical layer to the media access layer using the interface. The system may support a Peripheral Component Interconnect (PCI) Express (PCIe) Specification, a Universal Serial Bus (USB) Specification, a Serial ATA (SATA) Specification, or any combination thereof.

### EXAMPLE 3

A method is described herein. The method comprises building a data rate detector into a physical layer, and transmitting the data rate detected by the data rate detector to a media access control layer.

The data rate detector may be analog circuitry in the physical layer. The data rate detector may also comprise an edge detector and a counter. The edge detector may be a current mode logic (CML) edge detector. Additionally, the data rate detector comprises a linear equalization component. The method may comprise an interface between the physical layer and the media access layer, and wherein the data rate may be send from the physical layer to the media access layer using the interface. The interface may be a PHY Interface for the PCI Express, SATA, and USB SuperSpeed Architectures (PIPE) interface. Data may be transmitted according to a Peripheral Component Interconnect (PCI) Express (PCIe) Specification, a Universal Serial Bus (USB) Specification, a Serial ATA (SATA) Specification, or any combination thereof. Additionally, the data rate may be determined in response to a link exiting an electric idle state. The data rate detector may be powered off in response to determining the data rate.

### EXAMPLE 4

An apparatus is described herein. The apparatus comprises a means to determine a data rate in a physical layer. The apparatus also comprises a media access layer (MAC), wherein the media access layer is to receive the data rate from the physical layer.

The means to determine the data rate may comprise an edge detector and a counter. The edge detector may be a current mode logic (CML) edge detector. An equalization value of a signal may be increased to determine the data rate. Additionally, an equalization value may be a maximum value. The apparatus may comprise an interface between the physical layer and the media access layer, and wherein the data rate may be send from the physical layer to the media access layer using the interface. The interface may be a PHY Interface for the PCI Express, SATA, and USB SuperSpeed Architectures (PIPE) interface. The apparatus may support a Peripheral Component Interconnect (PCI) Express (PCIe) Specification, a Universal Serial Bus (USB) Specification, a Serial ATA (SATA) Specification, or any combination thereof. The data rate may be determined in response to a link exiting an electric idle state. Additionally, the means to determine the data rate may be powered off in response to determining the data rate.

### EXAMPLE 5

A non-transitory, computer readable medium is described herein. The computer readable medium comprises code to direct a processor to build a data rate detector into a physical layer and transmit the data rate detected by the data rate detector to a media access control layer.

The data rate detector may be analog circuitry in the physical layer. The data rate detector may comprise an edge detector and a counter. The edge detector may be a current mode logic (CML) edge detector. Additionally, the data rate detector may comprise a linear equalization component. Further, the computer readable medium may comprise interface between the physical layer and the media access layer, and wherein the data rate may be send from the physical layer to the media access layer using the interface. The interface may be a PHY Interface for the PCI Express, SATA, and USB SuperSpeed Architectures (PIPE) interface. Data may be transmitted according to a Peripheral Component Interconnect (PCI) Express (PCIe) Specification, a Universal Serial Bus (USB) Specification, a Serial ATA (SATA) Specification, or any combination thereof. Optionally, the data rate may be determined in response to a link exiting an electric idle state. The data rate detector may be powered off in response to determining the data rate.

While the present invention has been described with respect to a limited number of embodiments, those skilled in the art will appreciate numerous modifications and variations therefrom. It is intended that the appended claims cover all such modifications and variations as fall within the true spirit and scope of this present invention.

A design may go through various stages, from creation to simulation to fabrication. Data representing a design may represent the design in a number of manners. First, as is useful in simulations, the hardware may be represented using a hardware description language or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In any representation of the design, the data may be stored in any form of a machine readable medium. A memory or a magnetic or optical storage such as a disc may be the machine readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present invention.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example the decimal number ten may also be represented as a binary value of 1010 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, i.e. reset, while an updated value potentially includes a low logical value, i.e. set. Note that any combination of values may be utilized to represent any number of states.

Some embodiments may be implemented in one or a combination of hardware, firmware, and software. The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (i.e., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc, which are to be distinguished from the non-transitory mediums that may receive information there from.

Instructions used to program logic to perform embodiments of the invention may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments. Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In the foregoing specification, a detailed description has been given with reference to specific exemplary embodiments. It will, however, be evident that various modifications and changes may be made thereto without departing from the broader spirit and scope of the invention as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

What is claimed is:

1. An apparatus, comprising:
a physical layer (PHY), wherein analog circuitry of the physical layer is to determine a data rate;
a media access layer (MAC), wherein the media access layer is to receive the data rate from the physical layer.

2. The apparatus of claim 1, wherein the analog circuitry comprises an edge detector and a counter.

3. The apparatus of claim 2, wherein the edge detector is a current mode logic (CML) edge detector.

4. The apparatus of claim 1, wherein an equalization value of a signal is increased to determine the data rate.

5. The apparatus of claim 1, wherein an equalization value is a maximum value.

6. The apparatus of claim 1, comprising an interface between the physical layer and the media access layer, and wherein the data rate is send from the physical layer to the media access layer using the interface.

7. The apparatus of claim 6, wherein the interface is a PHY Interface for the PCI Express, SATA, and USB SuperSpeed Architectures (PIPE) interface.

8. The apparatus of claim 1, wherein the apparatus supports a Peripheral Component Interconnect (PCI) Express (PCIe) Specification, a Universal Serial Bus (USB) Specification, a Serial ATA (SATA) Specification, or any combination thereof.

9. The apparatus of claim 1, wherein the data rate is determined in response to a link exiting an electric idle state.

10. The apparatus of claim 1, wherein the analog circuitry is powered off in response to determining the data rate.

11. A system, comprising:
a transmission equalization (TxLe) component;
a continuous time linear equalization (CTLE) component;
a physical layer (PHY), wherein analog circuitry of the physical layer is to determine a data rate, the analog circuitry comprising an edge detector and a counter, and wherein the TxLE and the CTLE are to enable an equalization condition where the edge detector and counter are to determine the data rate;
a media access layer (MAC), wherein the media access layer is to receive the data rate from the physical layer.

12. The system of claim 11, wherein the edge detector is a current mode logic (CML) edge detector.

13. The system of claim 11, wherein data is transferred according to a PCI protocol, and wherein the equalization condition comprises a TX equalization preset #7.

14. The system of claim 11, wherein the equalization condition is equalization of a signal such that a substantial number of edges are to be detected.

15. The system of claim 11, wherein the counter is implemented digitally.

16. The system of claim 11, wherein the edge detector is a CML detector.

17. The system of claim 11, wherein a number of edges detected by the edge detector in a predetermined time period determines the data rate of a link.

18. The system of claim 11, wherein a time to forward data after a link exists, an electrical idle state may be decreased.

19. The system of claim 11, comprising an interface between the physical layer and the media access layer, and wherein the data rate is send from the physical layer to the media access layer using the interface.

20. The system of claim 11, wherein the system supports a Peripheral Component Interconnect (PCI) Express (PCIe) Specification, a Universal Serial Bus (USB) Specification, a Serial ATA (SATA) Specification, or any combination thereof.

21. A method comprising:
building a data rate detector into a physical layer; and
transmitting the data rate detected by the data rate detector to a media access control layer.

22. The method of claim 21, wherein the data rate detector is analog circuitry in the physical layer.

23. The method of claim 21, wherein the data rate detector comprises an edge detector and a counter.

24. The method of claim 23, wherein the edge detector is a current mode logic (CML) edge detector.

25. The method of claim 23, wherein the data rate detector comprises a linear equalization component.
